(19) United States
(12) Patent Application Publication
(10) Pub. No.: US 2013/0082470 A1
(43) Pub. Date: Apr. 4, 2013

(54) Pocket Sized Pet Waste Catch Tool and Carry Bag Kit

(71) Applicant: Kolua Seiko, Irvine, CA (US)

(72) Inventor: Kolua Seiko, Irvine, CA (US)

(21) Appl. No.: 13/559,588

(22) Filed: Jul. 26, 2012

Related U.S. Application Data
(60) Provisional application No. 61/572,983, filed on Jul. 26, 2011.

(51) Int. Cl. A01K 29/00

(52) U.S. Cl. CPC A01K 29/00
USPC 294/1.5

(57) ABSTRACT

An all-in one functional, hygienic, user/pet/environment secure (no contact with pet waste), highly user and pet adaptable pet waste catch, carry, and dispose tool kit with several unique features including its compact size for portability, ease of use for any size or physically limited user, adaptable to pet size and habits, usable with any kind of plastic bag, economically built with minimal parts and assembly, and hands free carrying of the tool, soiled plastic bags, and small items such as keys, gate keys, unused plastic bags, and treats in a multipurpose carry bag that can attach to leashes, belts, clothing, backpacks, purses, and wrists.

### CROSS REFERENCE TO RELATED APPLICATION

Provisional Application No. 61/572983 Filing date Jul. 26, 2011

### FIELD OF INVENTION

This invention pertains to an all inclusive, functional, handy all in one combination pet waste catch tool and carry bag that provides unique enhancements of use, conscious motivation to pet owners of their pet and environment responsibility and greater convenience through its multiple options for usability, hands free carrying (especially used bags), its discreetness, a multipurpose carry bag, adaptability to individual and pet needs and preferences, economy, its hygienic safety factors and ease of use.

### BACKGROUND AND PRIOR ART OF PET WASTE TOOLS

As a pet owner, the protection of my pet's health and well being as well as my community environment is a constant effort with the increase of pet population, contaminated environment and pet diseases. Despite civic efforts, community incentives such as bag dispensers and other services, many pet owners are reluctant to pick up after their pets. This reluctance is usually related to comfort, convenience, and cost factors. Understanding these underlying reasons and providing as many options as possible while reducing the stigma of contending with pet waste to a new perspective of social responsibility and a positive means to increase pet and environment safety, my invention can give pet owners, their pets, their community, and environment a new positive choice.

Prior art relating to pet tools that catch animal waste into a bag before it touches any surface, have hands-free capability, have a carry bag, use cord stops or have an adjustable catch include U.S. Pat. No. 4,363,508; U.S. Pat. No. 5,269,575; U.S. Pat. No. 5,403,050; U.S. Pat. No. 5,683,129; U.S. Pat. No. 6,039,370; U.S. Pat. No. 6,237,533; U.S. Pat. No. 6,702,349; U.S. Pat. No. 7,090,268 B2; 2008/0017121 A1; 2009/0079211 A1; U.S. Pat. No. 7,950,707;

My invention is a significant improvement over the prior art in:

Its innovative all-in-one approach to pet waste collection whereby all necessary elements to pet waste collection can be carried hands free in one unit, through its unique sleek, compact size, its ease of use, its multipurpose carry bag, its versatility, its sensitivity to owner and pet habits, raising social awareness, and its convenience in its multiple functions.

Shifting and maximizing social responsibility and legal directives of pet ownership in a positive, fun way as the invention is used.

Its practical usability in simply and quickly adjusting to an owner's size, habits, and comfort with its sliding telescopic stick and its movable catch that can be easily angled as well as its use of most commercial plastic bags.

Its facility to easily adjust to pet sizes, comfort, and habits such as when a pet moves during excreting especially to difficult terrain areas.

Its compact size for easy portability and its ease of use promotes its usage which enhances environmental safety, social responsibility, and hygienic practices to safeguard against the spread of disease.

Its simple construction of a telescopic stick and catch attached by a fastener such as a grommet making it both extremely economical to manufacture and to purchase while providing less breakability and longer use.

Its distinctive triangle shaped catch helps better hold plastic bags in place and for transferring urine or stool samples for medical testing into lab cups;

Its multiple hands free options provides more portability with its carry bag which can be attached to most leashes, clothing, or backpack and other attachable items or worn on the wrist or slipped into shirt, jacket, pant pocket or any clothing pocket.

Its added social conscious raising factor will not only encourage pet responsibility of owners through the carry bag social statements (“Clean and Green”) but will help pet owners overcome the stigma of pet waste to a more positive image of social consciousness and public safety thereby increasing its usage.

### DESCRIPTION OF DRAWINGS

FIG. 1—is a view of the elongated telescopic stick 4 with the catch 6 opened and the carry bag 22 attached to the tassel 16 of the pet waste tool and showing its general features of the handle 12 of the telescopic stick with its social awareness expression 14; the cord stops 20 & 20.1; the carry bag pocket 26; the carry bag social awareness expression 28; and the carry bag drawstring cord 24

FIG. 2—is a view of the collapsed telescopic stick 4 and folded catch 6 showing its compactness and social awareness expression 14 on the handle 16

FIG. 3—is a side view of the catch 6 showing details of its hardware to attach the catch 6 to the telescopic stick 4

FIG. 4—is a view of the catch 6 with its exploded hardware of washer 10 and fastener 8

FIG. 5—is a view of the catch 6 with a plastic bag 18 attached showing how the plastic bag 18 covers the entire catch 6 protecting it from any pet waste

FIG. 6 is a view of the carry bag 22 attached to a retractable leash 30 with plastic bags 18 held by its cord stops 20 & 20.1 showing plastic bags attached to the carry bag 22

FIG. 7—is a view of the method of attaching the cord stops 20 & 20.1 to a retractable leash 30 whereby cord stop 20.1 pulls the carry bag's 22 draw string cord 28 through the retractable leash handle 30. As the cord stop 20.1 and drawstring cord 28 come through the retractable leash handle 30 it is threaded in between the two drawstring cords 28 forming a loop. The cord stop 20.1 then is tightened by pushing it taut against the handle of the retractable leash 30 and thereby securing the carry bag 22 to the retractable leash 30.

FIG. 8—is a view of the cord stop 20 in locked position

FIG. 9—is a view of the cord stop 20 in unlocked position

### DESCRIPTION

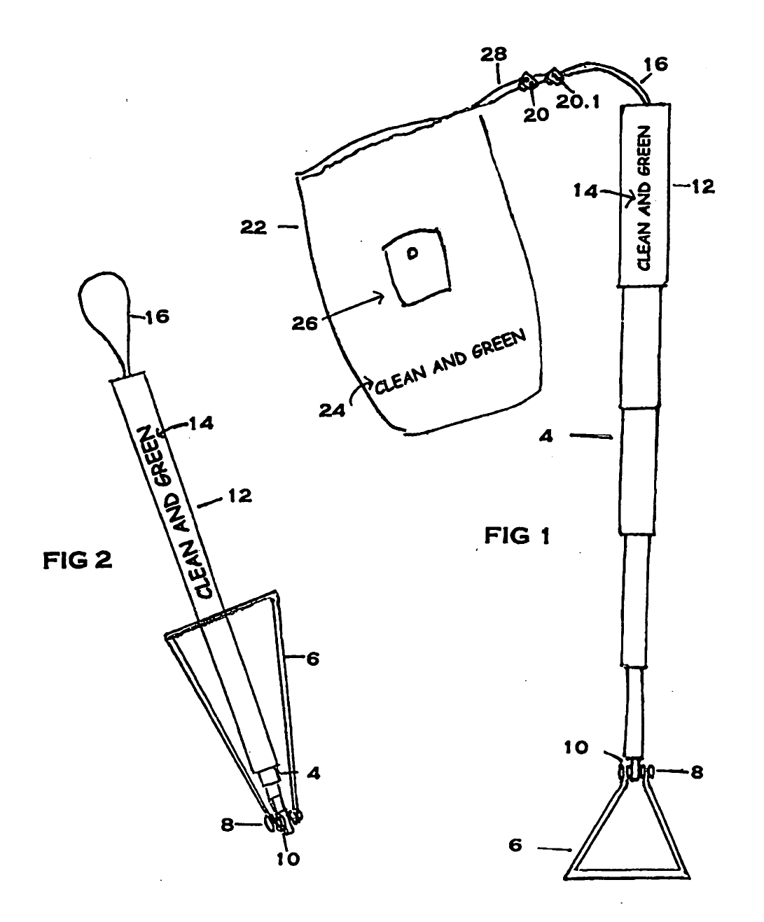

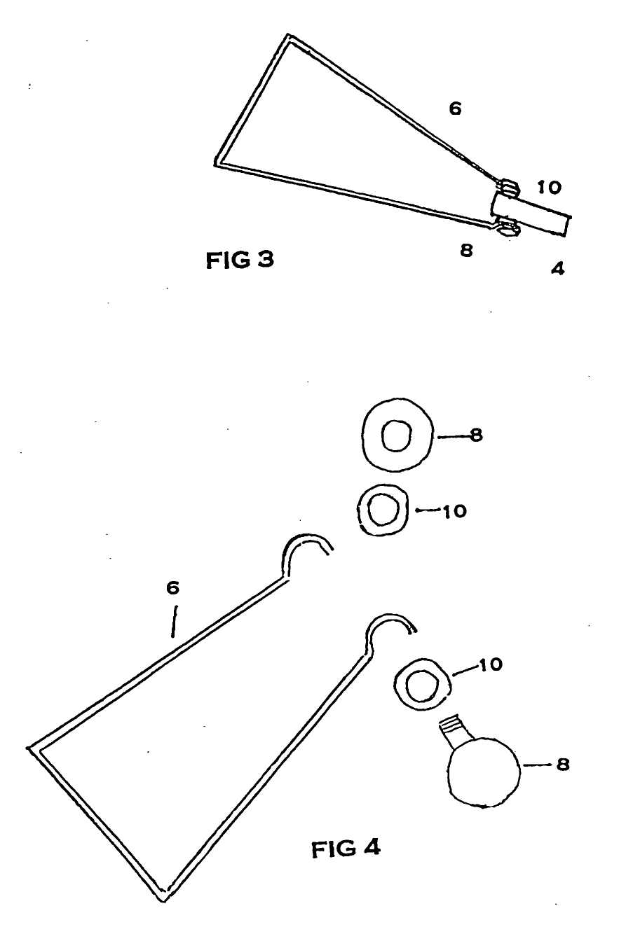

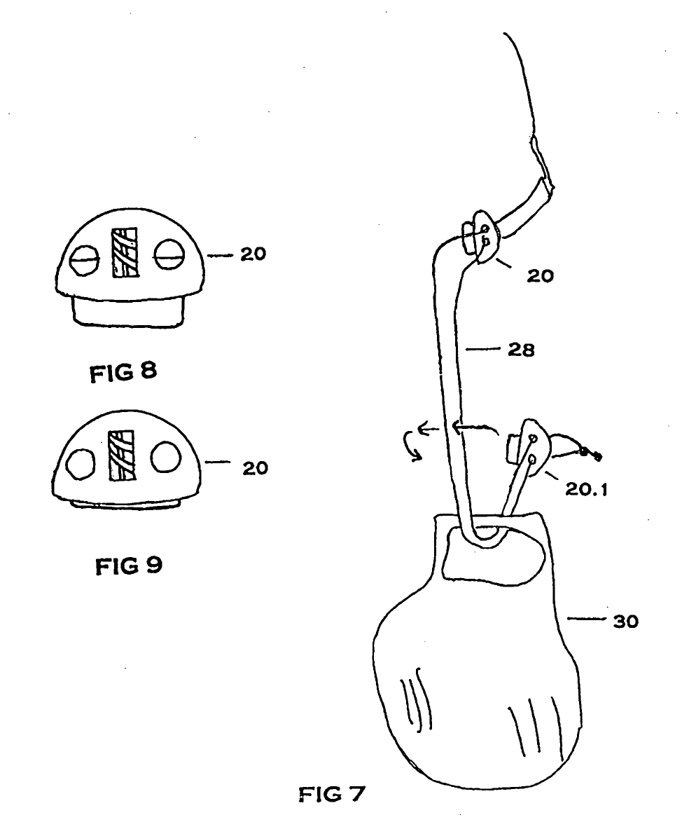

The invention is a resourceful, multi-tasking, sleek and compact, simply constructed, new and enhanced pet waste collection tool and disposal approach. These qualities and more will assure its use by pet owners as will its very functional hands free, all-in-one feature for everything necessary for fast and easy pet waste pick up and disposal. In FIG. 1 the telescopic stick 4 is fully extended and can include one or more segments that are configured to extend into an elongated stick of 28″ to 36″. The telescopic stick's variable length can quickly and easily adjust to owners' and the pets' particular height, comfort, habits, and needs by simply pulling on each segment to extend or retract it. The adjustable triangle shaped catch 6 will give further length and flexibility to both the owner's and pet's needs and is detailed below in FIG. 2 and FIG. 3. The telescopic stick 4 is made of lightweight aluminum or similar light weight material and can have either a regular or ergonomic handle 12 (Handle 12 is detailed further below in FIG. 2). The handle 12 has a tassel 16 affixed to its tip. The tassel 16 can be made with various materials such as plastic, leather or cloth; in this embodiment the tassel 16 is a nylon draw string cord and can be 5/32″ to 7/32″ in diameter. The tassel 16 can be put on the wrist as well as attached to the carry bag 22 through its cord stops 20 and 20.1 as shown in FIG. 1 and detailed in FIG. 7.

Attributes of pocket sized compactness and portability are key factors in enhancing usability by pet owners shown in FIG. 2 with the view of the pet waste catch tool folded into its pocket-sized portability of the collapsed telescopic stick 4 and the folded catch 6. The folded pet waste catch tool can be put on the wrist through its tassel 16 as an option for quick hands free operation. The handle 12 can be made of different substances such as plastic or rubber. An alternative embodiment could have the handle be ergonomic to provide greater comfort. The handle 12 has a social expression matching the social statement on the carry bag 22 and can alternatively have other social expressions or name of the pet or charity organization. In an alternative embodiment the handle can also match the fabric color and pattern of the carry bag 22 to further enhance the fun and usability of the invention.

FIG. 3 is a top view of the catch 6 showings its attachment to the telescopic stick. In FIG. 4 the detailed hardware parts include a plastic washer 10 and aluminum fastener 8 which hold the catch on either side of the telescopic stick. Alternatively in another embodiment the catch 6 can be attached to the telescopic stick 4 with other types of washers and fasteners such as steel washers or grommets. The catch 6 is made of aluminum coated with plastic, either 3½″ or 5″ wide, and can easily be adjusted to any angle from its folded position over the telescopic stick 4 as displayed in FIG. 2 to a complete rotation back to a folded position over the opposite side of the telescopic stick 4 thereby giving it a large range of adjustment. The catch's triangle shape can angle to accommodate various different sizes and habits of pets such as their ‘squat’ or motion during excreting. In terrain such as low bushes the angled catch can be especially useful in adjusting to both the pet and environment. In an alternative embodiment the catch 6 can be made of different materials including plastic, resin, or polyurethane.

FIG. 5 shows the catch 6 with a plastic bag 18 attached. Any kind of plastic bag can be used, but biodegradable bags are encouraged as part of the social consciousness of the invention. The triangle shape of the catch 6 helps keep the plastic bag 18 in place without added ties or snaps with the weight of the stools pulling the plastic bag 18 out of the catch 6. The plastic bag 18 is draped over so as not to soil any part of the catch 6 and as it drops out of the catch 6 the unsoiled outer part of the plastic bag 18 envelopes the inner soiled part of the plastic bag 18.

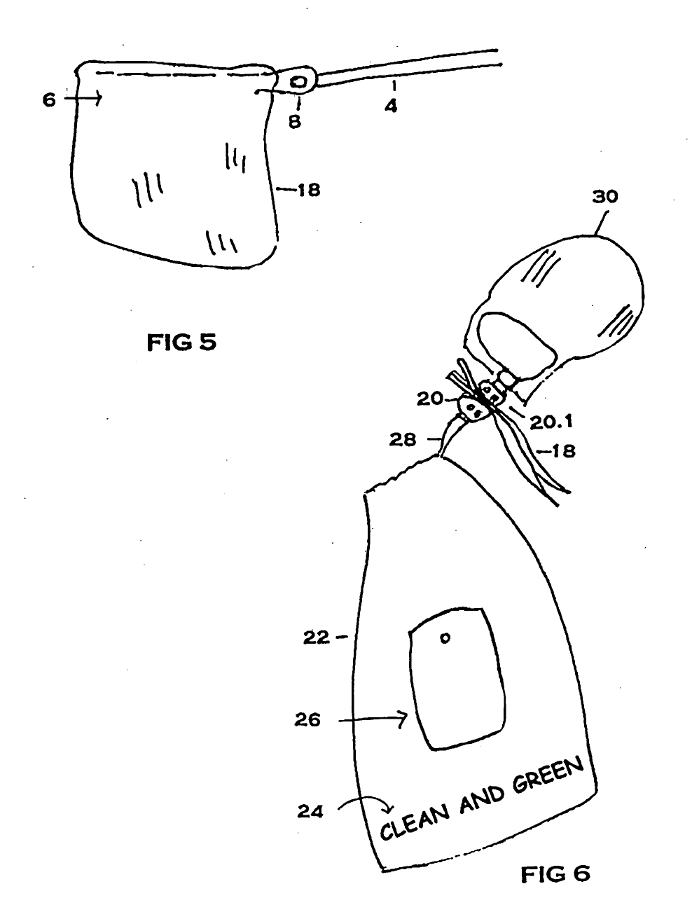

In FIG. 6 the carry bag 22 is attached to a retractable leash 30 by its drawstring cord 28 and is a convenient way to have hands free and also have both unused and used plastic bags 18 held by its cord stops 20 & 20.1. The cord stops 20 & 20.1 operate as the attaching mechanism and provide the carry bag's 22 ability to attach to various articles further detailed in FIG. 7. The carry bag 22 can be made of any kind of fabric such as nylon, cotton or rayon. The current embodiment of the carry bag 22 is a cotton fabric with the social expression 24, “Clean and Green”, displayed on both the carry bag 22 and the handle 12 of the telescopic stick 4. Alternative embodiments of other environmental or charity related mottos may be utilized to empower the spirit of the social consciousness through responsible pet ownership. The carry bag 22 comfortably holds the pet waste catch tool with room for unused plastic bags 18, keys, and other small items and can measure 7″ to 9″ in length and 4″ to 6″ in width. The carry bag 22 has a pocket 26 which can also carry small personal items for easy access and convenience. In an alternative embodiment the pocket 26 can have a clear plastic slot to slip in a photo of the pet or other photos.

The main element to attaching the carry bag 22 to various articles such as the retractable leash 30 in FIG. 7 are two cord stops 20 & 20.1 which are connected to the carry bag 22 by the carry bag drawstring cord 28. One of the cord stops 20.1 pulls the carry bag's 22 draw string cord 28 through the retractable leash handle 30 as shown in FIG. 7. As the cord stop 20.1 and drawstring cord 28 come through the retractable leash handle 30 it is threaded in between the two drawstring cords 28 forming a loop. The cord stop 20.1 then is tightened by pushing it taut against the handle of the retractable leash 30 and thereby securing the carry bag 22 to the retractable leash 30. Used plastic bags 18 can easily be held in the same manner by placing the used plastic bag 18 between the cord stop 20.1 and retractable leash or if particularly weighted from a large volume of pet waste can be safely secured by putting the knotted top of the plastic bag 18 between the drawstring cords and then drawing the cord stop 20 tautly against it opposite the cord stop 20.1.

The cord stops 20 & 20.1 as shown in FIG. 8 in a locked position and FIG. 9 in an open position are made of a connected to the carry bag 22 by the carry bag's drawstring cords 28 and are the attachment mechanisms for attaching the carry bag 22 to various objects described above. The method of attaching as explained above can be used in attaching the carry bag 22 to the telescopic stick tassel 16 as well as most leashes, bags, clothing, and other attachable objects.

1. I claim in this invention a combination of a pocket sized pet waste catch tool and carry bag with 2 cord stops as an all in one, hands free, economical, socially and environmentally responsible device for safe pet waste disposal.

2. The pocket size pet waste catch tool has an adjustable telescopic stick that extends 28″ to 36″ and can be made of any kind of metal or plastic. In this embodiment it is an aluminum metal telescopic stick that expands to 36″ and is attached to a triangle shaped catch to which a plastic bag is placed to cover the entire tool and then catch the pet waste as the pet is excreting its waste;
adjusting the angle, height, and distance according to the owner and pet's comfort and needs.

3. The pocket sized pet waste catch tool has an adjustable triangular catch which can be made of any type of plastic or light metal. In this embodiment, it is a plastic coated triangular catch which can be angled according to the owner and pet's comfort and needs. The catch can use any type of plastic bag, preferably a biodegradable bag to catch the pet waste. After completion of the pet's excreting, the plastic bag will easily slip through the catch without touching any part of the tool, owner, ground or pet and can be attached to the tool's tassel, in the carry bag or through the cord stops of the carry bag for proper disposal.

4. The carry bag with 2 cord stops can be made of any kind of fabric. In one embodiment it is made of cotton and 4″ to 6″ wide and 6″-9″ long; with a drawstring of 18″ made nylon or similar cloth, and two cord stops of either a single or double thread cord stop made of any kind of polyurethane. The carry bag can carry the pet waste catch tool, both soiled and unused plastic bags, keys, credit/gate cards, dog treats, small water bottles, and other small items. The outside of the bag can have a small pocket to also carry items as well as a distinct socially responsible statement such as “Clean and Green”. The carry bag can attach to leashes, belts or on the wrist and discreetly carry soiled plastic bags securely between the draw string and 2 cord stops to keep the carry bag contents from coming into contact with the soiled bag.
